(19) United States
(12) Patent Application Publication
(10) Pub. No.: US 2024/0061929 A1
(43) Pub. Date: Feb. 22, 2024

(54) MONITORING LIVE MEDIA STREAMS FOR SENSITIVE DATA LEAKS

(71) Applicant: International Business Machines Corporation, Armonk, NY (US)

(72) Inventors: Paritosh Ranjan, Kolkata (IN); BHUBANESWAR PADHAN, Kolkata (IN); Prosanta Saha, Kolkata (IN); PRODIP ROY, Kolkata (IN)

(73) Assignee: International Business Machines Corporation, Armonk, NY (US)

(21) Appl. No.: 17/891,647

(22) Filed: Aug. 19, 2022

(51) Int. Cl. G06F 21/55; G06F 21/62

(52) U.S. Cl. CPC G06F 21/552; G06F 21/6245; G06F 2221/034

(57) ABSTRACT

An embodiment includes capturing media data by sampling a media stream received from a web conferencing application during a web conference session between computing devices over a network, wherein the web conference session comprises content communicated as the media stream from a first computing device to a second computing device during the web conference session. The embodiment also includes generating a series of character codes representative of content of the media data by segmenting the media data and identifying character codes that most closely match respective segments. The embodiment also includes identifying sensitive information included in the series of character codes. The embodiment also includes generating, responsive to identifying the sensitive information, a notification regarding a potential leak of sensitive information, where the notification comprises an indication of the sensitive information identified in the series of character codes.

### BACKGROUND

The present invention relates generally to a method, system, and computer program product for data processing. More particularly, the present invention relates to a method, system, and computer program product for monitoring live media streams for sensitive data leaks.

Web conferences continue to become an increasingly popular way for two or more individuals to communicate over long distances. Web conferences may be enabled by a variety of different web conference applications. In general, web conferencing applications allow users to engage in audio and/or video conferencing, share files, presentations, virtual white boards, desktops, and other data while simultaneously conducting voice communications.

A person wishing to host a web conference (the “host”) operates web conferencing software to create and send conference invitations to intended meeting participants (“users”). Once a user is connected to the conference, the user may be granted permission to share their files, presentation, virtual white board, desktop, and other data with other conference participants and/or exchange files or other data. If the user's computer has a speaker and a microphone (or an audio headset), the user may speak with other conference participants through the established connection using VOIP (Voice Over Internet Protocol).

If the user's computer has a web camera, the user may establish a digital video stream of video captured by the web camera with other conference participants through the established connection or a new connection. Digital video streams typically represent video using a sequence of frames or still images. Each frame can include a number of blocks, which in turn may contain information describing the attributes for pixels of the frame.

### SUMMARY

The illustrative embodiments provide for monitoring live media streams for sensitive data leaks. An embodiment includes capturing, by one or more processors, media data by sampling a media stream received from a web conferencing application during a web conference session between computing devices over a network, where the web conference session comprises content communicated as the media stream from a first computing device to a second computing device during the web conference session. The embodiment also includes generating, by the one or more processors, a series of character codes representative of content of the media data by segmenting the media data and identifying character codes that most closely match respective segments. The embodiment also includes identifying, by the one or more processors, sensitive information included in the series of character codes. The embodiment also includes generating, by the one or more processors responsive to identifying the sensitive information, a notification regarding a potential leak of sensitive information, where the notification comprises an indication of the sensitive information identified in the series of character codes. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a cloud computing environment according to an embodiment of the present invention;

FIG. 2 depicts abstraction model layers according to an embodiment of the present invention;

FIG. 3 depicts a block diagram of a web conferencing environment that includes a service infrastructure in accordance with an illustrative embodiment;

FIG. 4 depicts a block diagram of example web conferencing environment for providing functionality described herein that can be utilized with a data leak detection system in accordance with illustrative embodiments;

FIG. 5 depicts a block diagram of example web conferencing environment for providing functionality described herein that can be utilized with a data leak detection system in accordance with illustrative embodiments;

FIG. 6 depicts a block diagram of an example data leak detection module in accordance with an illustrative embodiment;

FIG. 7 depicts block diagram of an example media processing engine in accordance with illustrative embodiments;

FIG. 8 depicts block diagram of an example media processing engine in accordance with illustrative embodiments;

FIG. 9 depicts block diagram of an example media processing engine in accordance with illustrative embodiments;

FIG. 10 depicts block diagram of an example sensitive data detection engine in accordance with illustrative embodiments;

FIG. 11 depicts a block diagram of an example sensitive data detection engine in accordance with an illustrative embodiment;

FIG. 12 depicts a block diagram of an example sensitive data detection engine in accordance with an illustrative embodiment; and

FIG. 13 depicts a flowchart of an example process for monitoring live media streams for sensitive data leaks in accordance with an illustrative embodiment.

### DETAILED DESCRIPTION

Web conferencing provides a popular way for two or more individuals to communicate over long distances. However, because web conferencing allows users to broadcast video of their workspace, computer desktop, application windows, and other imagery, there are instances where users inadvertently reveal more information than intended, which may include sensitive information.

As used herein, the term “sensitive information”, or “sensitive content”, or “confidential information”, or “confidential content” includes any information or content that is either legally confidential or identified by an individual/organization as being only intended to be seen/viewed by the user themselves or intended to be seen/viewed by any one or more other persons authorized by this user. Other terms may also be used to refer to information or content that is either legally confidential/sensitive or identified by an individual/organization as being only for the eyes of the user themselves, or any one or more other persons authorized by this user. Non-limiting examples of sensitive information include any data that could potentially be used to identify a particular individual (e.g., a full name, Social Security number, driver's license number, bank account number, passport number, and email address), financial information regarding an individual/organization, information deemed confidential by the individual/organization (e.g., contracts, sales quotes, customer contact information, phone numbers, sensitive information about individuals, and compensation information), and information classified by a governing authority as being confidential.

The disclosure of such sensitive information over a live web conference has the potential to jeopardize the security of systems and services associated with disclosed credentials or individuals associated with disclosed information. Accordingly, there is a need for more robust measures to make users aware of sensitive information leaks that may occur during a live web conference to allow measure to be taken to mitigate any damage that may stem from the disclosure.

Aspects of the present disclosure address the deficiencies described above by providing mechanisms (e.g., systems, methods, machine-readable media, etc.) that monitor live media streams for sensitive data leaks. An illustrative embodiment monitors a live media stream by sampling audio and/or video data in the media stream and processing the sampled data to determine if it contains an indication of sensitive data being revealed in the web conference media stream.

In some embodiments, a process for detecting sensitive information in a media stream of a live web conference includes generating a series of character codes, such as letters, numbers, or other characters, representative of audio and/or video content media stream. of the media data by segmenting the media data and identifying character codes that most closely match respective segments. In some such embodiments, the process analyzes the analyses the character codes to determine if they are representative of any sensitive information.

If sensitive information is detected, the process may trigger one or more actions. In some embodiments, if sensitive information is detected, the process may trigger a notification to the user hosting the web conference. The notification may include information about the sensitive information potentially revealed, such as the content of the information, the time in the web conference the information was detected, other users on the broadcast who may have noticed the information, whether a recording is being made of the media stream in which the sensitive information was revealed, or other related information.

In some embodiments, if sensitive information is detected, the process may trigger the removal or obscuring of video and/or audio that includes the sensitive information during the live broadcast and/or in recorded versions of the web conference. In some embodiments, if sensitive information is detected, the process may trigger an action by a hardware driver, such as a driver for the web camera or microphone to mute or temporarily disable the device capturing the sensitive material for some predetermined period of time to allow a moment for the host to remove the sensitive information from the capturing area.

In some embodiments, the process captures media data by sampling a media stream received from a web conferencing application during a web conference session between computing devices over a network, for example where the web conference session comprises content communicated as the media stream from a first computing device to a second computing device during the web conference session. In some embodiments, the media stream includes a video stream, and the process samples the video stream by extracting video frames for example every Nth video frame where N is a tunable parameter. In some embodiments, the media stream includes an audio stream, and the process samples the audio stream by extracting sections of the audio stream where each section spans a predetermined amount of time.

In some embodiments, the process generates a series of character codes representative of content of the media data, and then determines if the sensitive information is identified in in the series of character codes. In some embodiments, the process segments the media data and identifies character codes that most closely match respective segments. In some embodiments, the process generates character codes by performing an optical character recognition (OCR) process on extracted video frames. In some embodiments, the process generates a series of character codes by performing a speech-to-text natural language processing (NLP) algorithm on extracted sections of an audio stream. In some embodiments, the process performs a string-searching algorithm on the series of character codes, where the string-searching algorithm comprises a regular expression configured to detect sensitive information.

In some embodiments, the process generates a series of character codes by scanning a video frame for groups of words, numbers, or other character combinations and generating feature vectors that represent some context or characteristic of the groups of words, numbers, or other character combinations. In some embodiments, the process performs a machine learning process on the series of character codes, wherein the machine learning process comprises a machine learning model trained to detect sensitive information based on the context information in the feature vectors.

In some such embodiments, the process feature vectors include characteristic values for each of the scanned groups, where the characteristic values are higher for groups that are more likely to represent sensitive information. In some such embodiments, the process then performs a maxpooling operation to extract the feature value that corresponds with the scanned group that most likely represents sensitive data to determine whether the video frame is likely to include sensitive data.

In some embodiments, if sensitive information is identified, then the process triggers an action. For example, in some embodiments, if sensitive information is identified, the process generates a notification regarding a potential leak of sensitive information. The process then continues monitoring the live web conference for any other sensitive information leaks that may occur.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. The steps described by the various illustrative embodiments can be adapted for providing explanations for decisions made by a machine-learning classifier model, for example.

Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, contrastive explanations, computer readable storage medium, high-level features, training data, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefore, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

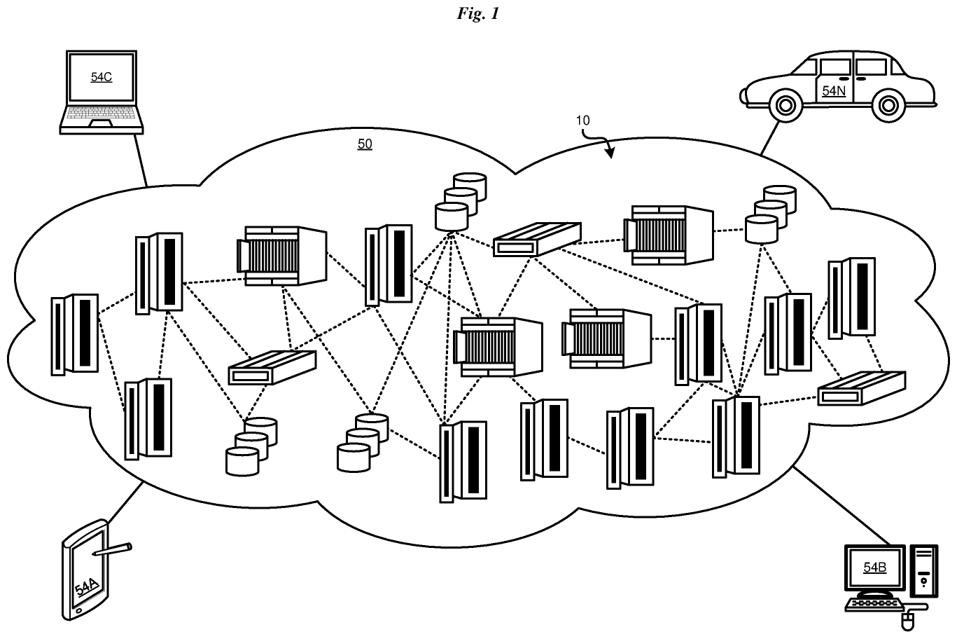

With reference to FIG. 1, this figure illustrates cloud computing environment 50. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

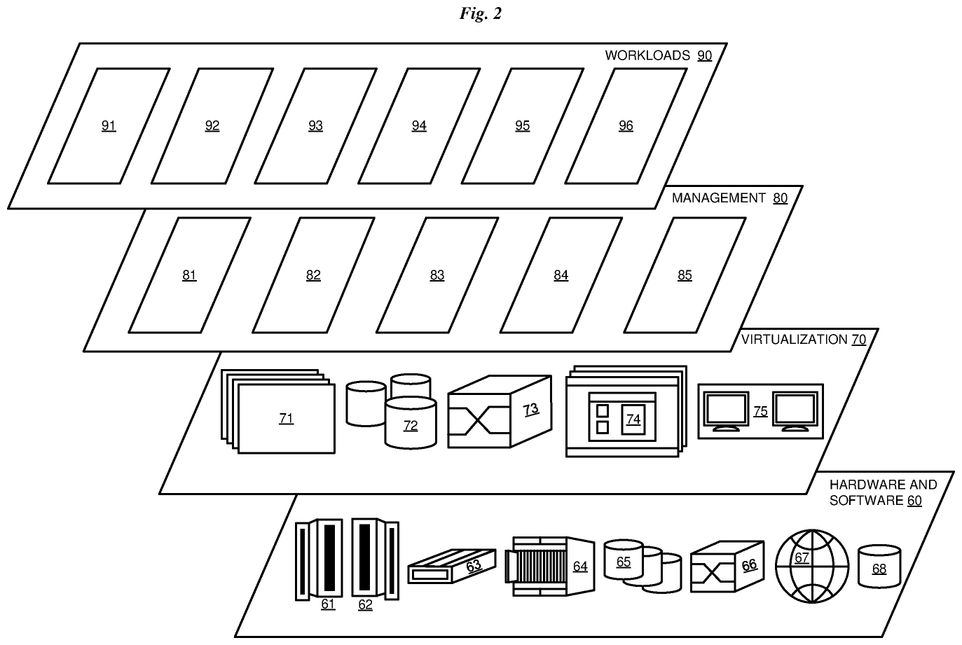

With reference to FIG. 2, this figure depicts a set of functional abstraction layers provided by cloud computing environment 50 (FIG. 1). It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and in the context of the illustrated embodiments of the present disclosure, various workloads and functions 96 for monitoring live media streams for sensitive data leaks. In addition, workloads, and functions 96 for monitoring live media streams for sensitive data leaks may include such operations as data analysis and machine learning (e.g., artificial intelligence, natural language processing, etc.), as described herein. In some embodiments, the workloads and functions 96 for monitoring live media streams for sensitive data leaks also works in conjunction with other portions of the various abstractions layers, such as those in hardware and software 60, virtualization 70, management 80, and other workloads 90 (such as data analytics processing 94, for example) to accomplish the various purposes of the disclosed embodiments.

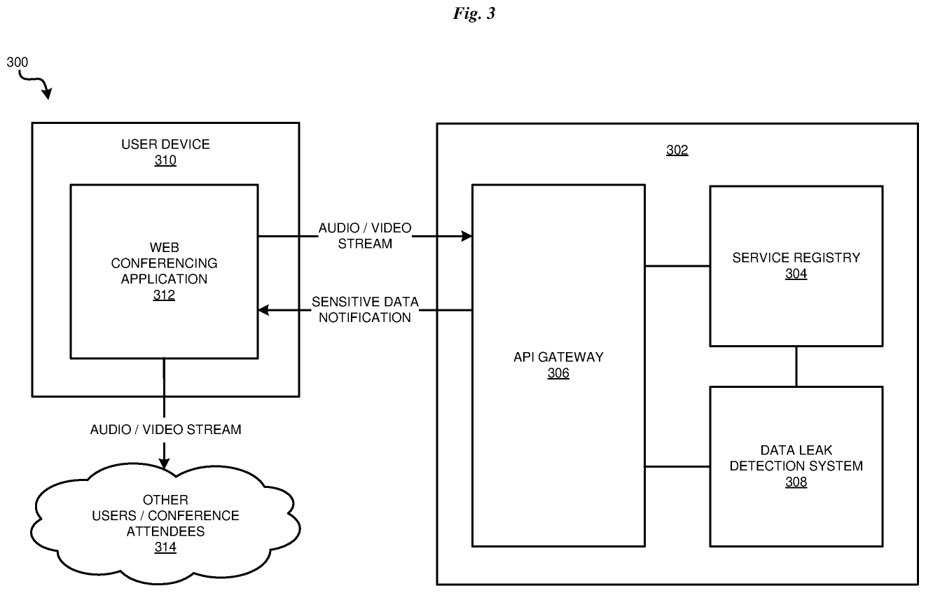

With reference to FIG. 3, this figure depicts a block diagram of a web conferencing environment 300 that includes a service infrastructure 302 in accordance with an illustrative embodiment. The service infrastructure 302 includes a data leak detection system 308 that, in some embodiments, is deployed in workloads layer 90 of FIG. 2. By way of example, in some embodiments, data leak detection system 308 is implemented as workloads and functions 96 for monitoring live media streams for sensitive data leaks in FIG. 2.

In the illustrated embodiment, the service infrastructure 302 provides data leak detection services and service instances to a user device 310. In some embodiments, the user device 310 is an example of a local computing device of FIG. 1, such as, for example, a personal digital assistant (PDA) or cellular telephone 54A, desktop computer 54B, laptop computer 54C, and/or automobile computer system 54N. User device 310 includes a web conferencing application 312 that enables the user device 310 to communicate with other users/conference attendees 314. In some embodiments, the web conferencing application 312 allows a user to engage in audio and/or video conferencing, share files, presentations, virtual white boards, desktops, and other data, including sensitive information, while simultaneously conducting voice communications with other users/conference attendees 314. However, when sensitive information is displayed, there is a risk that such displayed sensitive information may be leaked or otherwise compromised. For example, unauthorized persons nearby the display may be able to view the sensitive information being displayed on a display device.

Data leak detection system 308 provides data leak detection services at infrastructure 302 via an application programming interface (API) gateway 306. In various embodiments, service infrastructure 302 and its associated data leak detection system 308 serve multiple users and multiple tenants. A tenant is a group of users (e.g., a company) who share a common access with specific privileges to the software instance. Service infrastructure 302 ensures that tenant specific data is isolated from other tenants.

In some embodiments, user device 312 connects the web conferencing application 312 with API gateway 306 via any suitable network or combination of networks such as the Internet, etc. and use any suitable communication protocols such as Wi-Fi, Bluetooth, etc. Service infrastructure 302 may be built on the basis of cloud computing. API gateway 306 provides access to client applications like data leak detection system 308. API gateway 306 receives service requests issued by client applications, such as web conferencing application 312, and creates service lookup requests based on service requests.

In the illustrated embodiment, service infrastructure 302 includes a service registry 304. In some embodiments, service registry 304 looks up service instances of data leak detection system 308 in response to a service lookup request such as one from API gateway 306 in response to a service request from user device 312. For example, in some embodiments, the service registry 304 looks up service instances of data leak detection system 308 in response to requests from the user device 312 related to data leak detection services. In some embodiments, the web conferencing application 312 issues an API hook to the API gateway 306 that causes the data leak detection system 308 to commence monitoring a media (audio and/or video) stream from the web conferencing application 312 and issue a notification to the user device 310 if sensitive data is detected.

In some embodiments, the service infrastructure 302 includes one or more instances of the data leak detection system 308. In some such embodiments, each of the multiple instances of the data leak detection system 308 run independently on multiple computing systems. In some such embodiments, data leak detection system 308, as well as other service instances of data leak detection system 308, are registered in service registry 304.

In some embodiments, service registry 304 maintains information about the status or health of each service instance including performance information associated each of the service instances. For example, such performance information may include several types of performance characteristics of a given service instance (e.g., cache metrics, etc.). In some embodiments, the extended service registry 304 ranks service instances based on their respective performance characteristics and selects top-ranking service instances for classification requests. In some such embodiments, in the event that a service instance becomes unresponsive or, unhealthy, the service registry will no longer provide its address or information about this service instance to other services.

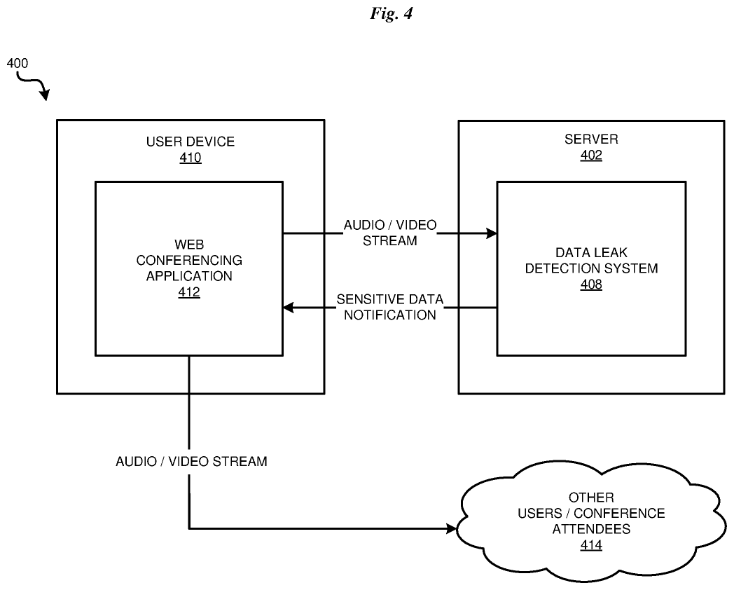

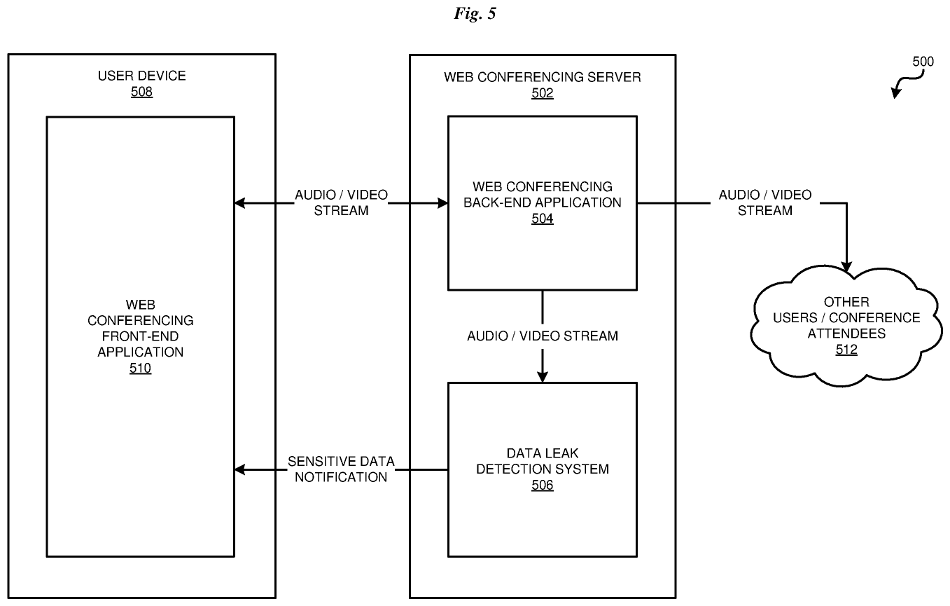

The functionality provided by the data leak detection system 308 is not limited to the arrangement shown in FIG. 3. Many other system arrangements or architectures are used in alternative embodiments, including the alterative embodiments shown in FIGS. 4 and 5.

With reference to FIG. 4, this figure depicts a block diagram of example web conferencing environment 400 for providing functionality described herein that can be utilized with a data leak detection system 408 in accordance with illustrative embodiments. The web conferencing environment 400 includes a server 402 that hosts the data leak detection system 408. In some embodiments, the server 402 is a web conferencing server associated with the web conferencing application 412 and the data leak detection system 408 is a module or add-in for the web conferencing application 412. In some embodiments, the server 402 is a web server that provides data leak detection services via the data leak detection system 408.

In the illustrated embodiment, the server 402 provides data leak detection services to a user device 410. In some embodiments, the user device 410 is an example of a local computing device of FIG. 1, such as, for example, a personal digital assistant (PDA) or cellular telephone 54A, desktop computer 54B, laptop computer 54C, and/or automobile computer system 54N. User device 410 includes a web conferencing application 412 that enables the user device 410 to communicate with other users/conference attendees 414. The data leak detection system 408 provides data leak detection services for the user device 410.

In some embodiments, the web conferencing application 412 issues a web hook to the server 402, for example by transmitting a POST that includes a unique and identifiable token to the server 402. The web hook triggers the data leak detection system 408 to connect to a web conference that the user of the user device 410 is attending or hosting via the web conferencing application 412. In some embodiments, the data leak detection system 408 may connect to the web conference in the same manner as the other users/conference attendees 414. Once connected, the data leak detection system 408 begins monitoring the media (audio and/or video) stream of the web conference for sensitive data and, in some embodiments, will issue a notification to the user device 410 if sensitive data is detected.

With reference to FIG. 5 this figure depicts a block diagram of example web conferencing environment 500 for providing functionality described herein that can be utilized with a data leak detection system 506 in accordance with illustrative embodiments. The web conferencing environment 500 includes a web conferencing server 502 that provides back-end functionality for web conferencing. In the illustrated embodiment, the back-end web conferencing support includes data leak detection provided by the data leak detection system 506.

In some embodiments, the user device 508 is an example of a local computing device of FIG. 1, such as, for example, a personal digital assistant (PDA) or cellular telephone 54A, desktop computer 54B, laptop computer 54C, and/or automobile computer system 54N. User device 508 includes a web conferencing application 510 that enables the user device 508 to communicate with other users/conference attendees 512. The data leak detection system 408 provides data leak detection services for the user device 508.

In some embodiments, the web conferencing application 510 connects to a web conference that is broadcast by the web conferencing back-end application 504. The web conference may be open to the public or may have restricted access. In the latter case, the web conferencing front-end application 510 may provide credentials to the web conferencing back-end application 504 in order to join the web conference. In some embodiments, the web conferencing back-end application 504 may trigger the data leak detection system 506 to begin monitoring the web conference upon detecting the start of the web conference. In some embodiments, the web conferencing back-end application 504 may trigger the data leak detection system 506 to begin monitoring the web conference upon detecting a request for leak monitoring services from a user, such as the web conference host. Once data leak monitoring has been triggered, the web conferencing back-end application 504 begins providing the media (audio and/or video) stream of the web conference to the data leak detection system 506. The data leak detection system 506 then monitors the media stream for sensitive data and, in some embodiments, will issue a notification to the user device 508, or to the web conferencing back-end application 504 or to another user device associated with the web conference host if sensitive data is detected.

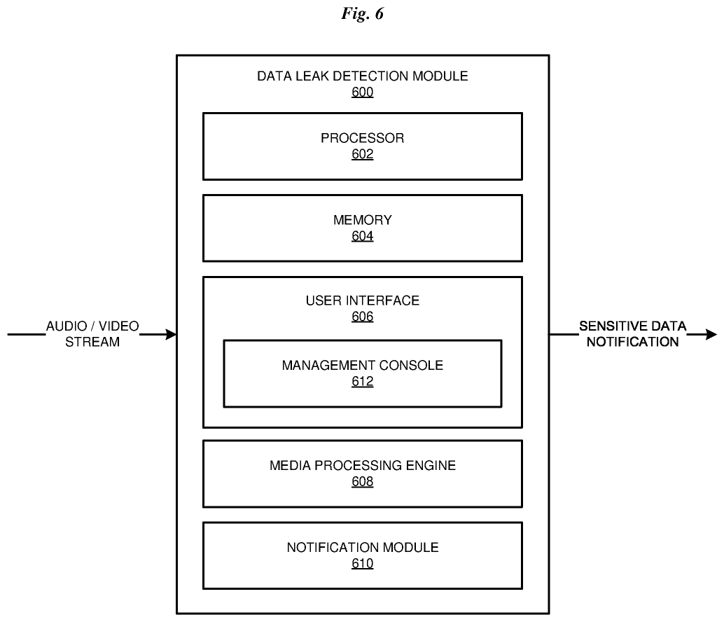

With reference to FIG. 6, this figure depicts a block diagram of an example data leak detection module 600 in accordance with an illustrative embodiment. In a particular embodiment, the data leak detection module 600 is an example of the data leak detection system 308, data leak detection system 408, and data leak detection system 506 shown in FIGS. 3-5, respectively.

In some embodiments, the data leak detection module 600 includes a processor 602, a memory 604, a user interface 606 that includes a management console 612, a media processing engine 608, and a notification module 610. In alternative embodiments, the data leak detection module 600 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

In the illustrated embodiment, the data leak detection module 600 includes a processing unit (“processor”) 602 to perform various computational and data processing tasks, as well as other functionality. The processor 602 is in communication with memory 604. In some embodiments, the memory 604 comprises one or more computer readable storage media with program instructions collectively stored on the one or more computer readable storage media, with the program instructions being executable by one or more processors 602 to cause the one or more processors 602 to perform operations described herein.

The data leak detection module 600 includes a user interface 606, which may include a graphic or command line interface. The management console 612 is an example of a graphical interface that allows a user to communicate with the data leak detection module 600. For example, in some embodiments, the management console 612 is configured to display menus, form, instructions, notifications, settings, and controls for issuing commands and adjusting settings all associated with the operation of the data leak detection module 600. In some embodiments, the management console 612 is configured to recognize and take action in response to requests programmatically from a user device (e.g., user device 310, user device 410, or user device 508).

In the illustrated embodiment, the data leak detection module 600 includes a media processing engine 608 that performs data leak monitoring tasks. In some embodiments, the media processing engine 608 captures media data by sampling a media stream received from a web conferencing application during a web conference session between computing devices over a network, for example where the web conference session comprises content communicated as the media stream from a first computing device to a second computing device during the web conference session. The media processing engine 608 may be triggered to monitor a media (audio and/or video) stream of a web conference. If the media processing engine 608 detects sensitive data in the media stream, the media processing engine 608 signals the notification module 610.

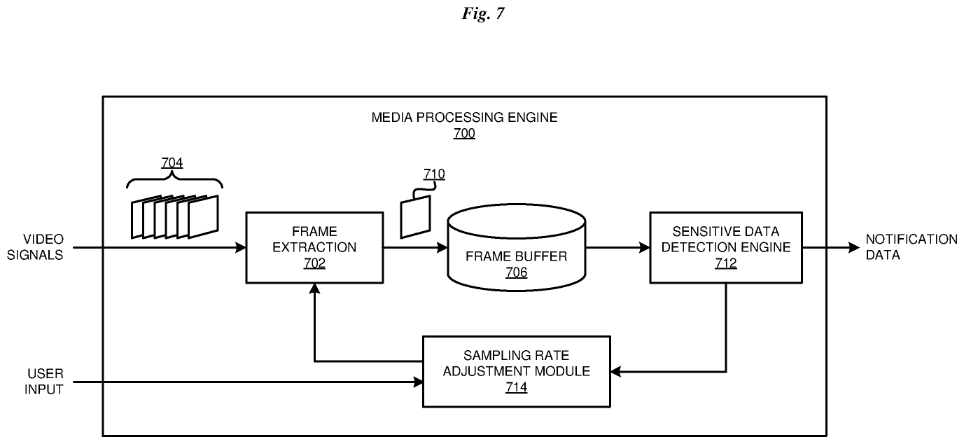

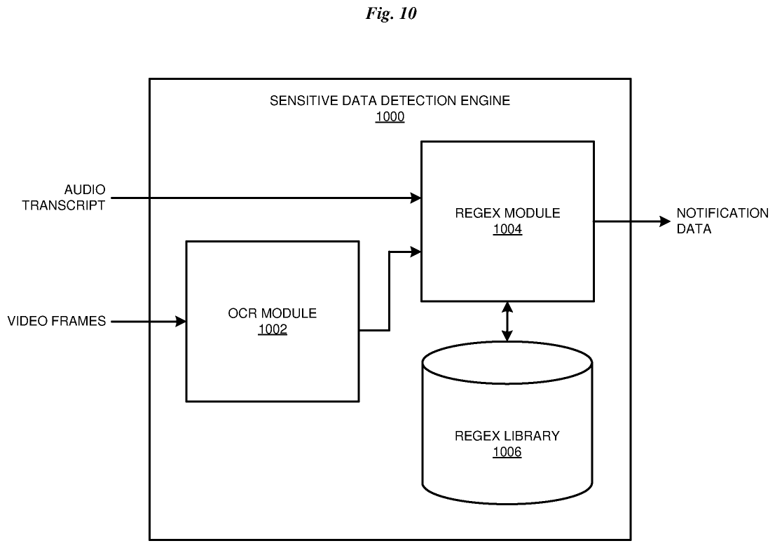

In some embodiments, the notification module 610 generates, responsive to identifying sensitive information, a notification regarding a potential leak of sensitive information. In some embodiments, the notification comprises an indication of the identified sensitive information. For example, upon receiving a signal form the media processing engine 608 indicative of detected sensitive information, the notification module 610 will issue a notification regarding the sensitive data. The type of notification and destination of the notification may vary and may depend on user-defined settings. In some embodiments, the notification may include issuing a message to one or more users. In some embodiments, the notification may include triggering additional actions, such as dropping or obscuring frames or audio that include the sensitive information such that the sensitive information is removed from the web conference during the live broadcast and/or in a recorded version of the web conference. In some embodiments, the media processing engine 608 in implemented according to any of the embodiments shown in FIGS. 7-9, using a sensitive data detection engine according to any of the embodiments shown in FIGS. 10-12.

With reference to FIG. 7, this figure depicts block diagram of an example media processing engine 700 in accordance with illustrative embodiments. In the illustrative embodiment, the media processing engine 700 is an example of the media processing engine 608 of FIG. 6 and includes a sensitive data detection engine according to any of the embodiments shown in FIGS. 10-12.

In the illustrative embodiment, the media processing engine 700 receives and monitors video signals of a live web conference, monitors the video signals for sensitive information, and issues notification data (e.g., to the notification module 610 of FIG. 6) if sensitive information is detected. In some embodiments, the media processing engine 700 captures media data in the form of video signal by sampling a video stream received from a web conferencing application during a web conference session between computing devices over a network, for example where the web conference session comprises content communicated as the media stream from a first computing device to a second computing device during the web conference session.

In the illustrative embodiment, the media processing engine 700 receives video signals in the form of a series of successive video frames 704 of a live web conference. In some embodiments, the frame extraction module 702 samples the video stream by extracting video frames from the video stream. In the illustrated embodiment, a frame extraction module 702 receives the incoming the video frames 704 and samples the video frames 704 by extracting a video frame 710. In some embodiments, the frame extraction module 702 extracts every Nth video frame, where N is a tunable parameter. In the illustrative embodiment, the frame extraction module 702 samples the incoming video according to a sampling rate set by a sampling rate adjustment module 714.

In the illustrated embodiment, the frame extraction module 702 stores the extracted video frame 710 frames in a frame buffer 706. The sensitive data detection engine 712 is configured to detect a buffered video frame 710 and retrieve the buffered video frame 710 for processing. In some embodiments, the sensitive data detection engine 712 processes the retrieved video frame 710 to determine whether the video frame 710 includes sensitive information.

In some embodiments, the sensitive data detection engine 712 is configured to detect that extracted video frames 710 are being buffered at a rate that is faster than the sensitive data detection engine 712 can process each video frame 710 and notify the sampling rate adjustment module 714. In some such embodiments, the sampling rate adjustment module 714 decreases the sampling rate of the frame extraction module 702 to prevent excessive frame buffering and allow the sensitive data detection engine 712 to stay current with the live web conference video stream.

Also, in some embodiments, the user is able to issue instructions to the sampling rate adjustment module 714 for adjusting the sampling rate of the frame extraction module 702. For example, the user may prioritize detection fidelity and wish to increase the sampling rate at the cost of increased frame buffering, or the user may prioritize performance and wish to decrease the sampling rate at the cost of decreased precision. For example, a video stream of a web conference may be received at a rate of 15 frames per second (fps) and the frame extraction module frame extraction 702 may be configured to sample the video stream by extracting every fifth frame. Thus, the fidelity of the sensitive data detection will default to 3 fps. The user may increase the sensitivity of the media processing engine 700 by increasing the sampling rate, for example to extract every third video frame, resulting in a sensitive data detection fidelity of 5 fps. However, this requires the sensitive data detection engine 712 to process the frames in 200 ms or less to keep up with the incoming video stream, which may or may not be feasible depending on several factors, such as the type and availability of system resources. On the other hand, if the frame buffering becomes too excessive, the user may decrease the sensitivity of the media processing engine 700 by decreasing the sampling rate, for example to extract every eighth video frame, resulting in a sensitive data detection fidelity of approximately 2 fps. This increases the time allowed for the sensitive data detection engine 712 to process the frames to about 533 ms or less to keep up with the incoming video stream. While this may improve performance by reducing frame buffering, the tradeoff is a reduction in fidelity to about 2 fps, in which case the media processing engine 700 may not detect sensitive data that appears in the video stream for less than about half a second.

In some embodiments, the sampling rate adjustment module 714 is configured to maintain an optimum balance between performance and fidelity by continuously adjusting the sampling rate of the frame extraction module frame extraction 702. If there are periods of time in which no frames are in the frame buffer 706 while there is an incoming video stream, the sampling rate adjustment module 714 can increase the sampling rate; if buffering becomes excessive and the sensitive data detection engine 712 begins to fall behind the live steam, the sampling rate adjustment module 714 can reduce the sampling rate.

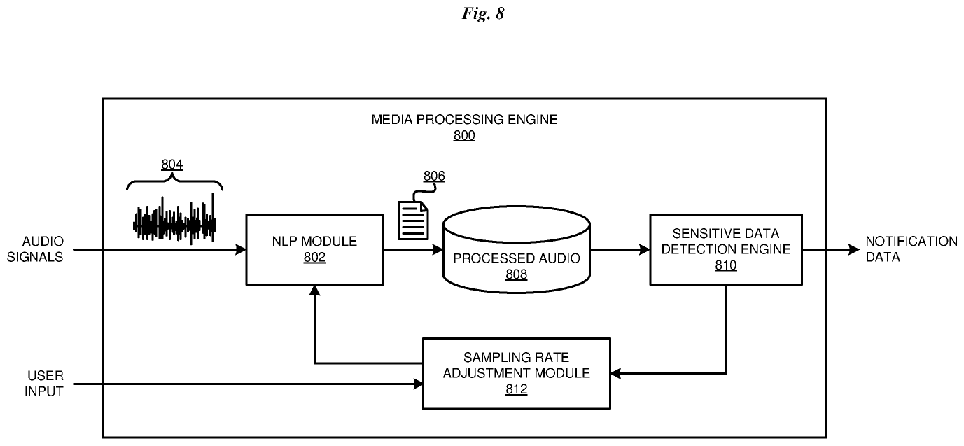

With reference to FIG. 8, this figure depicts block diagram of an example media processing engine 800 in accordance with illustrative embodiments. In the illustrative embodiment, the media processing engine 800 is an example of the media processing engine 608 of FIG. 6 and includes a sensitive data detection engine according to any of the embodiments shown in FIGS. 10-12.

In the illustrative embodiment, the media processing engine 800 receives and monitors audio signals of a live web conference, monitors the audio signals for sensitive information, and issues notification data (e.g., to the notification module 610 of FIG. 6) if sensitive information is detected. In some embodiments, the media processing engine 800 captures media data in the form of audio signal by sampling an audio stream received from a web conferencing application during a web conference session between computing devices over a network, for example where the web conference session comprises content communicated as the media stream from a first computing device to a second computing device during the web conference session.

In the illustrative embodiment, the media processing engine 800 receives audio signals in the form of a series of successive audio sections 804 of a live web conference. In some embodiments, the NLP module 802 samples the audio stream by extracting audio sections from the audio stream. In the illustrated embodiment, a NLP module 802 receives the incoming the audio sections 804 and samples the audio sections 804 by extracting an audio section and generating a transcript 806 of the audio section. In some embodiments, the NLP module 802 extracts and transcribes the incoming audio steam in time-based sections, where each section is t seconds, for example where by default t=5 seconds or some other value, and t is a tunable parameter. In the illustrative embodiment, the NLP module 802 samples the incoming audio, for example by introducing unprocessed time intervals in between the sections of audio that are transcribed. In some embodiments, the sampling rate is a ratio of processed to discarded audio. For example, at a sampling rate of 10p/d, the NLP module 802 transcribes 5 seconds of audio, then discards 500 ms of audio before transcribing the next 5 seconds of audio. This sampling rate can be adjusted to adjust the work load on the sensitive data detection engine 810 and allow it to keep the sensitive data detection processing in sync with the audio of a live audio stream. In some embodiments, the sampling rate is set by the sampling rate adjustment module 812.

In the illustrated embodiment, the NLP module 802 stores the extracted audio transcript 806 in a processed audio buffer 808. The sensitive data detection engine 810 is configured to detect a buffered audio transcript 806 and retrieve the buffered audio transcript 806 for processing. In some embodiments, the sensitive data detection engine 810 processes the retrieved audio transcript 806 to determine whether the audio transcript 806 includes sensitive information.

In some embodiments, the sensitive data detection engine 810 is configured to detect that extracted audio transcripts 806 are being buffered at a rate that is faster than the sensitive data detection engine 810 can process each audio transcript 806 and notify the sampling rate adjustment module 812. In some such embodiments, the sampling rate adjustment module 812 decreases the sampling rate of the NLP module 802 to prevent excessive buffering and allow the sensitive data detection engine 810 to stay current with the live web conference audio stream. Also, as described in connection with the media processing engine 700, in some embodiments the user is able to issue instructions to the sampling rate adjustment module 812 for adjusting the sampling rate of the NLP module 802. However, there is a tradeoff between performance and sampling fidelity. In some embodiments, the sampling rate adjustment module 812 is configured to maintain an optimum balance between performance and fidelity by continuously adjusting the sampling rate of the NLP module 802. If there are periods of time in which no transcripts 806 are in the processed audio transcript buffer 808 while there is an incoming audio stream, the sampling rate adjustment module 812 can increase the sampling rate; if buffering becomes excessive and the sensitive data detection engine 810 begins to fall behind the live steam, the sampling rate adjustment module 812 can reduce the sampling rate.

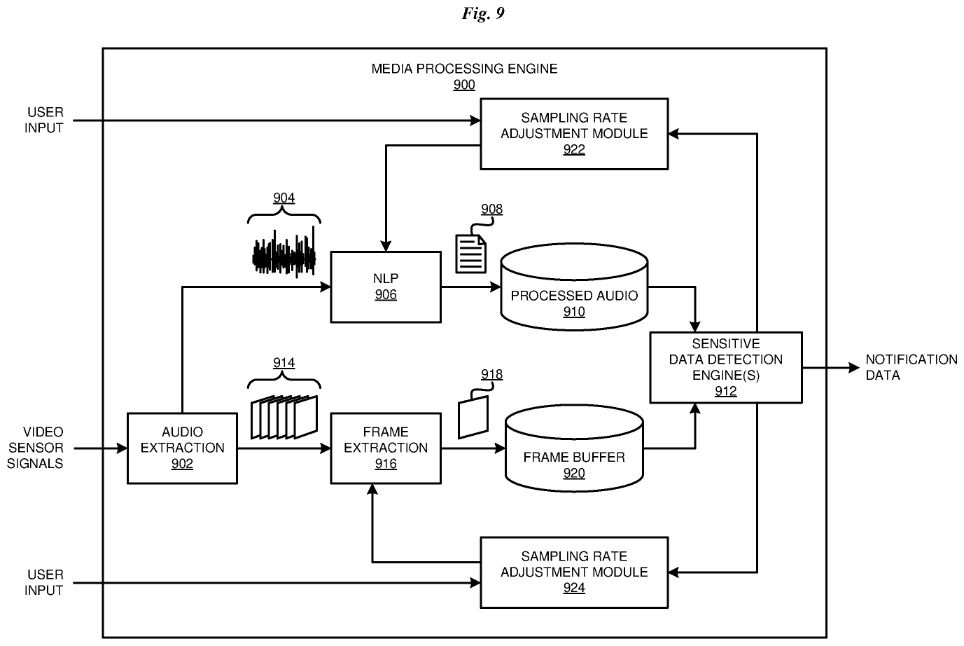

With reference to FIG. 9, this figure depicts block diagram of an example media processing engine 900 in accordance with illustrative embodiments. In the illustrative embodiment, the media processing engine 900 is an example of the media processing engine 608 of FIG. 6 and includes a sensitive data detection engine according to any of the embodiments shown in FIGS. 10-12.

In the illustrative embodiment, the media processing engine 700 receives audio and video signals of a live web conference, monitors the audio and video signals for sensitive information, and issues notification data (e.g., to the notification module 610 of FIG. 6) if sensitive information is detected. The media processing engine 900 includes an audio extraction module 902 that separates the incoming audio signal from the incoming video signal. The incoming audio 904 is sent to an NLP module 906, which is an example of the NLP module 802 of FIG. 8. The incoming video frames 914 are sent to a frame extraction module 916, which is an example of the frame extraction module 702 of FIG. 7. From this point, the frame extraction module 916 outputs a video frame 918 to a frame buffer 920 for processing by a sensitive data detection engine 912 according to a sampling rate set by a sampling rate adjustment module 924 in the same manner described in connection with FIG. 7, and the NLP module 906 outputs a transcript 908 to a processed audio transcript buffer 910 for processing by a sensitive data detection engine 912 according to a sampling rate set by a sampling rate adjustment module 922 in the same manner described in connection with FIG. 8. In some embodiments, the media processing engine 900 may include two or more sensitive data detection engine(s) 912 operating in parallel to process the audio and/or video streams.

With reference to FIG. 10, this figure depicts block diagram of an example sensitive data detection engine 1000 in accordance with illustrative embodiments. In some embodiments, the sensitive data detection engine 1000 is an example of the sensitive data detection engine 712 of FIG. 7, the sensitive data detection engine 810 of FIG. 8, and the sensitive data detection engine(s) 912 of FIG. 9.

In the illustrated embodiment, the sensitive data detection engine 1000 includes an OCR module 1002, a regular expression (regex) module 1004, and a regex library 1006. In alternative embodiments, the sensitive data detection engine 1000 can include some or all of the functionality described herein but grouped differently into one or more modules.

In the illustrated embodiment, the sensitive data detection engine 1000 is configured to receive audio transcripts and video frames. In alternative embodiments, the sensitive data detection engine 1000 may be configured to receive only audio transcripts or only video frames.

In the illustrated embodiment, incoming video frames are processed by the OCR module 1002. In some embodiments, the OCR module 1002 generates character bounding boxes and OCR-assigned character codes for the bounding boxes. The OCR module 1002 processes a video frame and segments the video frame into separated images corresponding to separated recognized characters. The OCR module 1002 produces and uses a bounding box to enclose and to identify one or more separately recognized characters. Each OCR character code can represent one or more characters. Each character can include one or more language tokens where a language token is a fundamental unit of a language and can include, for example, a letter, a numeral, and a symbol or mark. A symbol or mark can be, for example, a punctuation mark, a typographical mark, or a diacritical mark.

In some embodiments, the OCR module 1002 generates character codes corresponding to a series of characters represented by regions of a video frame by performing OCR processing on received video frames resulting in a transcription of text appearing in each frame, where the transcription comprises the series of character codes. For example, in some embodiments, the OCR module 1002 is configured to analyze various symbols or objects in each video frame, and when a symbol or object is identified that corresponds to a character code that is a letter, the OCR module 1002 translates the symbol or object into the corresponding letter. For example, when the OCR module 1002 recognizes an object in a video frame that corresponds to two vertical lines separated by two opposing slanting lines, the symbol or object may be translated into the letter “M” by the OCR module 1002.

In the illustrated embodiment, the regex module 1004 receives text either as an audio transcript or text detected in a video frame by the OCR module 1002. The regex module 1004 applies sensitive-data-detection rules to the incoming text, where the rules may include any suitable number of regular expressions stored in a regex library 1006 that are particularly configured to identify sensitive information. In some examples, the regular expressions indicate patterns of text that match sensitive data. For example, a number of numerical digits separated by periods may correspond to an Internet Protocol (IP) address or, if separated by dashes, may correspond to a phone number or birth date. As an example, the regular expression “[0-9] {3}-[0-9]{3}-[0-9]{4}” may indicate that the sensitive data corresponds to three numerical values followed by a dash and three numerical values followed by a dash and four numerical values, which would detect a phone number that follows this pattern. Many other regular expressions may be included to detect any desired pattern that may correspond to sensitive information. If text matches a regular expression, the regex module 1004 will generate and output notification data indicating that sensitive information has been detected. In some embodiments, the regex module 1004 generates, responsive to identifying sensitive information, notification data regarding a potential leak of sensitive information. In some embodiments, the regex module 1004 generates notification data that comprises an indication of the identified sensitive information.

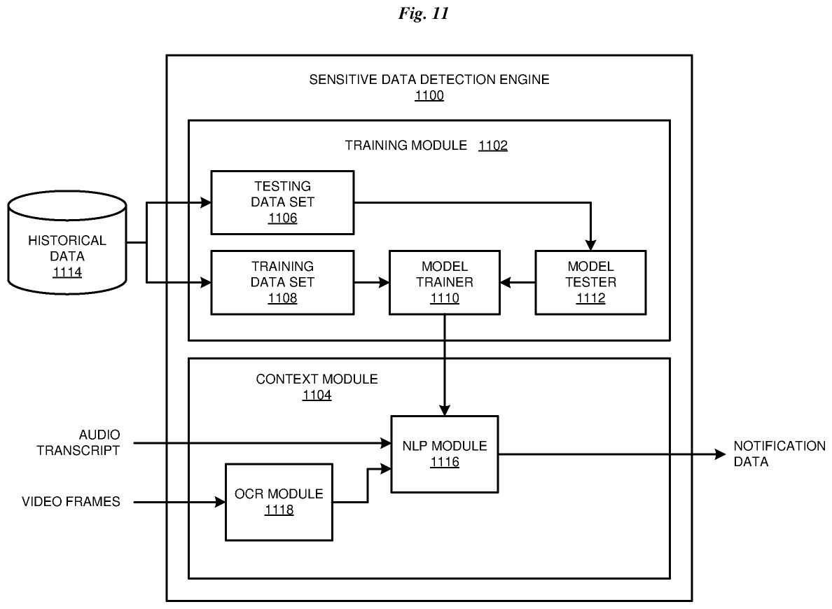

With reference to FIG. 11, this figure depicts a block diagram of an example sensitive data detection engine 1100 in accordance with an illustrative embodiment. The sensitive data detection engine 1100 uses a machine-learning approach to detecting sensitive information in text or other characters extracted from a media stream of a live web conference. In some embodiments, the sensitive data detection engine 1100 is an example of the sensitive data detection engine 712 of FIG. 7, the sensitive data detection engine 810 of FIG. 8, and the sensitive data detection engine(s) 912 of FIG. 9.

In the illustrated embodiment, the sensitive data detection engine 1100 is configured to receive audio transcripts and video frames. In alternative embodiments, the sensitive data detection engine 1100 may be configured to receive only audio transcripts or only video frames.

In the illustrated embodiment, the sensitive data detection engine 1100 includes a training module 1102 and a context module 1104. In some embodiments, the training module 1102 generates an NLP model used by the context module 1104 to detect sensitive information in incoming audio transcripts and/or video frames. There are many different types of models that can be used in various implementations, such as word2vec, fastText, Glove, and Bert. The training module 1102 includes a model trainer 1110 that trains the NLP model using training data, which may include historical data from a historical data storage 1114. The term “historical data,” as used herein, refers to data that is familiar to users seeking to train a machine-learning model. For example, in some embodiments, the historical data includes a training dataset designed to train a machine-learning model that will be able to generalize enough to accurately make predictions about new data, for example about features or objects that are not part of the training dataset. In some embodiments, the training module 1102 may be configured to train a “pre-trained” model. For example, embodiments that use a Bert model may begin with a model that has already been trained to generally understand language and context, and the training module 1102 trains the model to recognize sensitive information.

In some embodiments, the training module 1102 receives historical data from a historical data storage 1114 and divides it into a training data set 1108 and a testing data set 1106. In some embodiments, a model tester 1112 uses the testing data set 1106 to test the trained model for problems, such as overfitting, before the trained model is ready for production in the context module 1104.

In the illustrated embodiment, incoming video frames are processed by an OCR module 1118 in the same manner described in connection with the OCR module 1002 of FIG. 10. In the illustrated embodiment, the NLP module 1116 includes the NLP model trained by the training module 1102 and receives text either as an audio transcript or text detected in a video frame by the OCR module 1118. The NLP module 1116 inputs the text into the trained NLP model, which outputs an indication that the text includes, or does not include, sensitive information. In some embodiments, the NLP model outputs a value indicating a likelihood that the text includes sensitive information, and the value for the likelihood that triggers a notification can be a tunable parameter. In some embodiments, the NLP module 1116 generates, responsive to identifying sensitive information, notification data regarding a potential leak of sensitive information. In some embodiments, the NLP module 1116 generates notification data that comprises an indication of the identified sensitive information.

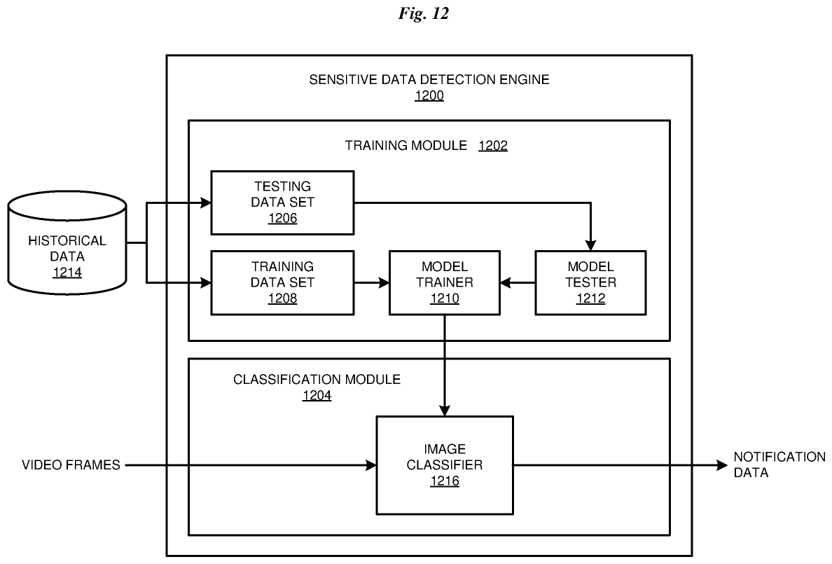

With reference to FIG. 12, this figure depicts a block diagram of an example sensitive data detection engine 1200 in accordance with an illustrative embodiment. The sensitive data detection engine 1200 uses a machine-learning image classification approach to detecting sensitive information in video frames extracted from a media stream of a live web conference. In some embodiments, the sensitive data detection engine 1200 is an example of the sensitive data detection engine 712 of FIG. 7.

The sensitive data detection engine 1200 uses a machine-learning image classifier to analyze video frames as images. Therefore, the sensitive data detection engine 1200 does not require separate OCR processing. Instead, the video frames are processed directly and classified as including or not-including sensitive data.

In the illustrated embodiment, the sensitive data detection engine 1200 includes a training module 1202 and a classification module 1204. In some embodiments, the training module 1202 generates a machine-learning image classification model that serves as the image classifier 1216 of the classification module 1204. The training module 1202 includes a model trainer 1210 that trains the image classification model using training data, which may include historical data from a historical data storage 1214. In some embodiments, the historical data includes a training dataset designed to train a machine-learning model that will be able to generalize enough to accurately make predictions about new data, for example about features or objects that are not part of the training dataset.

In some embodiments, the training module 1202 receives historical data from a historical data storage 1214 and divides it into a training data set 1208 and a testing data set 1206. In some embodiments, a model tester 1212 uses the testing data set 1206 to test the trained model for problems, such as overfitting, before the trained model is ready for production in the classification module 1204.

In some embodiments, the image classifier 1216 is trained to detect sensitive information in incoming video frames. In some embodiments, the image classifier 1216 is a deep neural network (DNN). There are many different ways of designing a DNN that can be used as the image classifier 1216, for example using different layering structures, different types of layers, and different ways of connecting the nodes. A convolutional neural network (CNN) is an example of a DNN that can be used as the image classifier 1216. A CNN is a network that contains one or more convolutional layers that use an algorithm to extract features from an image, regardless of the locations of the features in the image. In some embodiments, the image classifier 1216 is a CNN that is trained to recognize words, numbers, or other character combinations using word embeddings, which are feature vectors where each value of the feature vector represents a feature of a word and different unique combinations of feature values represent different words. In some such embodiments, the CNN can then determine whether any of the identified sequences of characters are likely to represent sensitive data. In some embodiments, the image classifier 1216 is a CNN that uses a kernel window that scans a video frame and captures groups of words, numbers, or other character combinations and generates higher level feature vectors that represent some context or characteristic of the groups of words, numbers, or other character combinations. In some such embodiments, the CNN generates a feature vector that includes characteristic values for each of the scanned groups, where the characteristic values are higher for groups that are more likely to represent sensitive information. In some such embodiments, the CNN then performs a maxpooling operation to extract the feature value that corresponds with the scanned group that most likely represents sensitive data to determine whether the video frame is likely to include sensitive data. If the output of the maxpooling operation is low, then the image classifier 1216 considers the video frame to be free of sensitive information. Otherwise, the image classifier 1216 generates a notification data regarding a potential leak of sensitive information in the video frame. In some embodiments, the image classifier 1216 generates notification data that comprises an indication of the identified sensitive information.

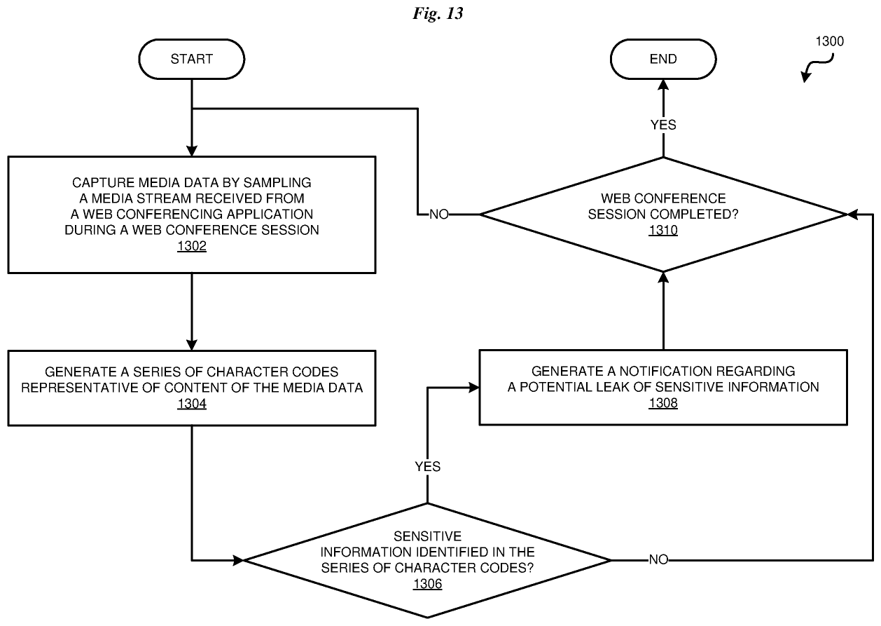

With reference to FIG. 13, this figure depicts a flowchart of an example process 1300 for monitoring live media streams for sensitive data leaks in accordance with an illustrative embodiment. In a particular embodiment, the data leak detection system 308 of FIG. 3, data leak detection system 408 of FIG. 4, or data leak detection system 506 of FIG. 5 carries out the process 1300.

In an embodiment, at block 1302, the process captures media data by sampling a media stream received from a web conferencing application during a web conference session between computing devices over a network, for example where the web conference session comprises content communicated as the media stream from a first computing device to a second computing device during the web conference session. In some embodiments, the media stream includes a video stream, and the process samples the video stream by extracting video frames for example every Nth video frame where N is a tunable parameter. In some embodiments, the media stream includes an audio stream, and the process samples the audio stream by extracting sections of the audio stream where each section spans a predetermined amount of time.

Next, at block 1304, the process generates a series of character codes representative of content of the media data, and then at block 1306, the process determines if sensitive information is identified in in the series of character codes. In some embodiments, the process segments the media data and identifies character codes that most closely match respective segments. In some embodiments, the process generates character codes by performing an OCR process on extracted video frames. In some embodiments, the process generates a series of character codes by performing a speech-to-text natural language processing (NLP) algorithm on extracted sections of an audio stream. In some embodiments, the process performs a string-searching algorithm on the series of character codes, where the string-searching algorithm comprises a regular expression configured to detect sensitive information.

In some embodiments, the process generates a series of character codes by scanning a video frame for groups of words, numbers, or other character combinations and generating feature vectors that represent some context or characteristic of the groups of words, numbers, or other character combinations. In some embodiments, the process performs a machine learning process on the series of character codes, wherein the machine learning process comprises a machine learning model trained to detect sensitive information based on the context information in the feature vectors.

In some such embodiments, the process feature vectors include characteristic values for each of the scanned groups, where the characteristic values are higher for groups that are more likely to represent sensitive information. In some such embodiments, the process then performs a maxpooling operation to extract the feature value that corresponds with the scanned group that most likely represents sensitive data to determine whether the video frame is likely to include sensitive data.

If sensitive information is identified at block 1306, then the process continues to block 1308, where the process generates a notification regarding a potential leak of sensitive information. In some embodiments, the notification comprises an indication of the sensitive information identified in the series of character codes. The process then continues to block 1310 either after block 1308 or if no sensitive information is identified at block 1306. At block 1310, the system determines if the web conference is still ongoing, for example by detecting additional incoming video and/or audio of the live web conference. If so, the process returns to block 1302. Otherwise, the process is complete.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM) or Flash memory, a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
capturing, by one or more processors, media data by sampling a media stream received from a web conferencing application during a web conference session between computing devices over a network, wherein the web conference session comprises content communicated as the media stream from a first computing device to a second computing device during the web conference session;
generating, by the one or more processors, a series of character codes representative of content of the media data by segmenting the media data and identifying character codes that most closely match respective segments;
identifying, by the one or more processors, sensitive information included in the series of character codes; and
generating, by the one or more processors responsive to identifying the sensitive information, a notification regarding a potential leak of sensitive information, wherein the notification comprises an indication of the sensitive information identified in the series of character codes.

2. The method of claim 1, wherein the media stream comprises a video stream, and wherein the capturing of the media data comprises sampling the video stream by extracting a video frame from the video stream.

3. The method of claim 2, wherein the sampling of the video stream comprises extracting every Nth video frame, wherein N is a tunable parameter.

4. The method of claim 2, wherein the generating of the series of character codes comprises generating character codes corresponding to a series of characters represented by the media data by performing an optical character recognition (OCR) process on the video frame resulting in a transcription of text appearing in the video frame, wherein the transcription comprises the series of character codes.

5. The method of claim 2, wherein the generating of the series of character codes comprises generating a feature vector using a neural network, wherein the series of character codes represent respective values of the feature vector, wherein the values of the feature vector represent respective local features of the video frame.

6. The method of claim 5, wherein the identifying of the sensitive information included in the series of character codes comprises:
performing a maxpooling operation on the feature vector resulting in a representative feature of the video frame; and
detecting that the representative feature is indicative of sensitive information.

7. The method of claim 1, wherein the media stream comprises an audio stream, and wherein the capturing of the media data comprises extracting a section of the audio stream that comprises audio that spans a predetermined period of time.

8. The method of claim 7, wherein the generating of the series of character codes comprises performing a natural language processing (NLP) algorithm on the section of the audio stream resulting in a transcription of the audio, wherein the transcription comprises the series of character codes.

9. The method of claim 1, wherein the identifying of the sensitive information included in the series of character codes comprises performing a string-searching algorithm on the series of character codes, wherein the string-searching algorithm comprises a regular expression configured to detect sensitive information.

10. The method of claim 1, wherein the identifying of the sensitive information included in the series of character codes comprises performing a machine learning process on the series of character codes, wherein the machine learning process comprises a machine learning model trained to detect sensitive information.

11. A computer program product, the computer program product comprising one or more computer readable storage media, and program instructions collectively stored on the one or more computer readable storage media, the program instructions executable by one or more processors to cause the one or more processors to perform operations comprising:
capturing, by one or more processors, media data by sampling a media stream received from a web conferencing application during a web conference session between computing devices over a network, wherein the web conference session comprises content communicated as the media stream from a first computing device to a second computing device during the web conference session;
generating, by the one or more processors, a series of character codes representative of content of the media data by segmenting the media data and identifying character codes that most closely match respective segments;
identifying, by the one or more processors, sensitive information included in the series of character codes; and
generating, by the one or more processors responsive to identifying the sensitive information, a notification regarding a potential leak of sensitive information, wherein the notification comprises an indication of the sensitive information identified in the series of character codes.

12. The computer program product of claim 11, wherein the stored program instructions are stored in a computer readable storage device in a data processing system, and wherein the stored program instructions are transferred over a network from a remote data processing system.

13. The computer program product of claim 11, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

14. The computer program product of claim 11, wherein the media stream comprises a video stream, and wherein the capturing of the media data comprises sampling the video stream by extracting a video frame from the video stream.

15. The computer program product of claim 14, wherein the sampling of the video stream comprises extracting every Nth video frame, wherein N is a tunable parameter.

16. The computer program product of claim 11, wherein the media stream comprises an audio stream, and wherein the capturing of the media data comprises extracting a section of the audio stream that comprises audio that spans a predetermined period of time.

17. A computer system comprising one or more processors and one or more computer readable storage media, and program instructions collectively stored on the one or more computer readable storage media, the program instructions executable by the one or more processors to cause the one or more processors to perform operations comprising:
capturing, by one or more processors, media data by sampling a media stream received from a web conferencing application during a web conference session between computing devices over a network, wherein the web conference session comprises content communicated as the media stream from a first computing device to a second computing device during the web conference session;
generating, by the one or more processors, a series of character codes representative of content of the media data by segmenting the media data and identifying character codes that most closely match respective segments;
identifying, by the one or more processors, sensitive information included in the series of character codes; and
generating, by the one or more processors responsive to identifying the sensitive information, a notification regarding a potential leak of sensitive information, wherein the notification comprises an indication of the sensitive information identified in the series of character codes.

18. The computer system of claim 17, wherein the media stream comprises a video stream, and wherein the capturing of the media data comprises sampling the video stream by extracting a video frame from the video stream.

19. The computer system of claim 18, wherein the sampling of the video stream comprises extracting every Nth video frame, wherein N is a tunable parameter.

20. The computer system of claim 17, wherein the media stream comprises an audio stream, and wherein the capturing of the media data comprises extracting a section of the audio stream that comprises audio that spans a predetermined period of time.
